(19) United States
(12) Patent Application Publication
(10) Pub. No.: US 2009/0258324 A1
(43) Pub. Date: Oct. 15, 2009

(54) Nozzle for Insertion Into Tooth Root Canal, and Device for Treating Tooth Root Canal, Having the Nozzle for Insertion Into Tooth Root Canal

(76) Inventors: Takatomo Yoshioka, Tokyo (JP); Yasue Fukumoto, Tokyo (JP); Hideaki Suda, Tokyo (JP); Toshiharu Hanzaka, Nagano (JP); Toshimitsu Nogami, Nagano (JP)

Correspondence Address: SCHWEGMAN, LUNDBERG & WOESSNER, P.A., P.O. BOX 2938, MINNEAPOLIS, MN, 55402, US

(21) Appl. No.: 12/226,305

(22) PCT Filed: Apr. 16, 2007
(86) PCT No.: PCT/JP2007/058235

§ 371 Date: Jan. 8, 2009

(30) Foreign Application Priority Data
Apr. 14, 2006 (JP) 2006-112616

(51) Int. Cl. A61C 5/02; A61C 5/04

(52) U.S. Cl. 433/81; 433/91

(57) ABSTRACT

A nozzle for insertion into a tooth root canal, which can be inserted into the depths of the root canal, which enables a sufficient amount of fluid to be allowed to flow through it per unit time, and which can be easily produced, and a device for treating a tooth root canal, provided with the nozzle. A treating device (1) has an injection device (10) and a discharge device (20). The injection device (10) has a treatment liquid receiving container (14) and also has a supply nozzle (11) communicating with the treatment liquid receiving container (14) through a supply tube (13). The discharge device (20) has a suction nozzle (21) inserted from one end into a tooth root canal (610), a discharge tube (22) connected to the other end of the suction nozzle (21), a discharge pump (23) provided in the middle of the discharge tube (22), and a waste liquid receiving container (24) communicating with the suction nozzle (21) through the discharge pump (23). The suction nozzle (21) has a substantially circular tube-like body section having a predetermined dimension and a substantially circular tube-like extension section extending from the forward end of the body section, having a smaller outer diameter than the body section, and having a predetermined dimension.

### TECHNICAL FIELD

The present invention relates to a nozzle for insertion into a tooth root canal, and to a device for treating a tooth root canal provided with the nozzle for insertion into the tooth root canal.

### BACKGROUND ART

Treatment of diseases inside the root canal of a tooth is carried out by the following treatment method.

The treatment method includes the procedure of physically removing contaminants such as bacteria by enlarging the subject tooth root canal; the procedure of, after washing with a treatment fluid, removing the treatment fluid, cuttings, blood and the like from inside the root canal; and the procedure of filling the inside of the root canal with a filler.

By this treatment method, by first physically removing contaminants, and washing the inside of the root canal with a treatment fluid, the bacteria which are the origin of diseases inside the root canal are removed and killed. Further, by filling the inside of the root canal after removing the treatment fluid and the like, the inside of the root canal is blocked from the surroundings, and a bacteria-free state is maintained. Accordingly, it is possible to treat diseases inside the root canal of a tooth.

A treatment device of the prior art used in such treatment of such diseases inside the root canal has a constitution such as the following, for example (refer to Patent Document 1).

FIG. 16 is a schematic constitutional view of the treatment device 500 of the prior art example.

The treatment device 500 is provided with an injector 510 for injecting the treatment fluid into the tooth root canal 610, and a discharge device 520 for discharging the treatment fluid from the tooth root canal 610.

The injector 510 has a treatment fluid holding tank 514 which holds the treatment fluid, a supply pump 513 which pumps the treatment fluid held in the treatment fluid holding tank 514 to the supply tube 512, and a supply nozzle 511 which communicates with the treatment fluid holding tank 514 via the supply tube 512 and which supplies the treatment fluid to the tooth root canal 610.

Further, the discharge device 520 has a suction nozzle 521 which is inserted into the tooth root canal 610 from one end side, a discharge tube 522 connected to the other end of this suction nozzle 521, a discharge pump 523 which communicates via this discharge tube 522 and which suctions the treatment fluid injected into the tooth root canal 610, and a waste liquid holding tank 524 which communicates with the suction nozzle 521 via the discharge tube 522 and which holds the suctioned treatment fluid.

With this treatment device 500, a part of the treatment (washing the inside of the root canal with the treatment fluid) of a disease inside root canal of a tooth can be carried out by a procedure such as the following.

First, the suction nozzle 521 is inserted from one end side into the tooth root canal 610. The suction nozzle 521 reaches a position where its outer diameter approximately matches the diameter of the tooth root canal 610. When the supply pump 513 and the discharge pump 523 operate in this state, the treatment fluid supplied to the supply nozzle 511 from the treatment fluid holding tank 514 via the supply tube 512 is injected to the tooth root canal 610 from the tip of the supply nozzle 511, and the injected treatment fluid is suctioned from the tip of the suction nozzle 521 to the inside of the suction nozzle 521. The treatment fluid suctioned into the inside of the suction nozzle 521 is conveyed to the waste liquid holding tank 524 via the discharge tube 522, and held in the waste liquid holding tank 524. The direction in which the treatment fluid flows is as shown by the arrows in FIG. 16.

Subsequently, at a suitable point in time, the supply pump 513 and the discharge pump 523 are stopped and the injection and suctioning of the treatment fluid are finished. Then, the suction nozzle 521 is withdrawn from the tooth root canal 610, and the cleaning inside the root canal by the treatment fluid is concluded.

Further, as a treatment device of the prior art used for treatment of diseases inside a root canal, a treatment device having a constitution such as the following can be mentioned (refer to Patent Document 2).

FIG. 17 is a complete perspective view of the treatment apparatus 800 of the prior art example.

The treatment device 800 is provided with a cylindrical cylinder 810 having an inner portion supply source of the filler, not shown in the figure, a handle 820 arranged at one end of this cylinder 810, and a cylindrical filler nozzle 900 protruding from the other end of the cylinder 810.

In the inner portion of the cylinder 810, a piston, not shown, is slidably engaged, and by sliding this piston towards the other end side of the cylinder 810, the filler is extruded. For the piston, a rod 840 is lengthwise provided which is capable of sliding in the inner portion of the cylinder 810, and for this rod 840, via a screw portion provided on its side surface, a locking nut 850 and an operation (manipulation) pad 860 are sequentially screw-engaged.

Further, the inner portion of the filler nozzle 900 is communicated with the inner portion of the cylinder 810.

With this treatment device 800, a part of the treatment (filling the inside of a tooth root canal with the treatment fluid) of a disease inside a root canal of a tooth can be carried out by a process such as the following.

First, the handle 820 is grasped and the operation pad 860 is pulled in the rear direction, and the piston is pulled out of the cylinder 810. Subsequently, after filling the filler in the inner portion of the cylinder 810, the piston is inserted into the cylinder 810.

Next, after inserting the tip of the filler nozzle 900 into the tooth root canal, the operation pad is pressed in the forwards direction, the filler is supplied to the filler nozzle 900 and injected from the tip of the filler nozzle 900 into the tooth root canal.

After this, at a suitable point in time, by withdrawing the filler nozzle 900 from the tooth root canal, the filling of the inside of the tooth root canal is concluded.

Patent Document 1: Japanese Unexamined Patent Publication No. 2004-313659

Patent Document 2: Japanese Publication No. H1-40621 of International Application

### DISCLOSURE OF THE INVENTION

### Problems to be Solved by the Invention

However, a tooth root canal 610 has a shape which gradually becomes narrower towards its deep portion (the downwards direction in FIG. 16), and thus, there were the following problems in the above-mentioned treatment device 500.

If the outer diameter of the suction nozzle 521 is made larger, then the tip is stopped at a shallow portion of the tooth root canal 610. Because the treatment fluid injected into the tooth root canal 610 is suctioned by the tip of the suction nozzle 521 which is stopped at a shallow portion, it does not reach the deep portions of the tooth root canal 610. Because of this, bacteria and the like remain in the deep portion of the tooth root canal 610, and there have been cases of diseases inside the root canal of a tooth reoccurring due to re-proliferation.

On the other hand, if the outer diameter of the suction nozzle 521 is made smaller, the inner diameter of the suction nozzle 521 will inevitably also have to be made smaller, and thus the channel for the suctioned treatment fluid will also become narrower. As a result, the suctioned amount of treatment fluid per unit time is reduced, and thus, the speed of the treatment is lost, and there are cases where the treatment fluid that is not suctioned overflows from the opening or root apex of the tooth root canal 610 into the oral cavity.

If the inner diameter of the suction nozzle 521 becomes small, contaminants mixed in with the suctioned treatment fluid may easily clog the suction nozzle 521.

Likewise, there were the following problems with the treatment device 800 mentioned above.

If the outer diameter of the filler nozzle 900 is made large, the tip is stopped at a shallow portion of the tooth root canal. Because of this, the filler injected into the tooth root canal does not reach the deep portions of the tooth root canal, and there have been cases where the deep portions of the tooth root canal have not been filled by the filler.

On the other hand, if the outer diameter of the filler nozzle 900 is made smaller, the inner diameter of the filler nozzle 900 will inevitably also have to be made smaller, and thus the channel for the supplied filler will also become narrower. As a result, the supplied amount of filler per unit time is reduced, and thus, the speed of the treatment is lost. As a result, the filler cools and solidifies in the inner portion of the filler nozzle 900, and clogs in the inner portion of the filler nozzle.

In order to solve problems such as the above, it can be considered to make the inner diameter and the outer diameter of the suction nozzle 521 and the filler nozzle 900 have a shape which is gradually reduced (for example a tapered shape). However, because the suction nozzle 521 and the filler nozzle 900 have very small dimensions, the processing for gradually reducing the inner diameter is technically difficult.

The present invention takes into account the above conflicting requirements, and has the objective of providing a nozzle for insertion into a tooth root canal which can be inserted into a deep portion of a tooth root canal, and which further can circulate a sufficient amount of fluid per unit time, and which can be easily manufactured; and a device for treating a tooth root canal provided with this nozzle for insertion into a tooth root canal.

### Means for Solving the Problems

The present invention specifically provides the following.

The first aspect of the invention is a nozzle for insertion into a tooth root canal, inserted from one end side into the tooth root canal, and used for injecting into the tooth root canal or suctioning from the tooth root canal a fluid,

comprising a cylindrical main body portion, and a cylindrical extension portion extending from a tip of the main body portion and with having an outer diameter and an inner diameter each of which is smaller than the main body portion.

A cylindrical body, unlike a shape where the outer diameter and inner diameter are gradually reduced (for example a tapered shape), can be easily manufactured even if its dimensions are small.

According to the first aspect of the invention, a nozzle for insertion into a tooth root canal can be manufactured if, from the tip of an easily manufactured cylindrical main body portion, a likewise easily manufactured cylindrical extension portion is extended, and thus the manufacture can be easily carried out.

Further, the nozzle for insertion into a tooth root canal is constituted comprising a main body portion, and an extension portion having a smaller outer diameter than the main body portion, thus, while the main body portion is stopped at a shallow portion of the tooth root canal and cannot be inserted into a deep portion, the extension portion can reach a deep portion of the tooth root canal. Because of this, a fluid can be injected into a deep portion of the tooth root canal, or can be suctioned from a deep portion of the tooth root canal.

Further, the inner diameter of the main body portion is larger than the inner diameter of the extension portion, and thus, it is possible to suppress reductions in the injected amount or suctioned amount per unit time of the fluid due to providing the extension portion, and a sufficient amount of fluid can be injected or suctioned per unit time.

Accordingly, the nozzle of this aspect can circulate a sufficient amount of fluid per unit time and can be injected to a deep portion of the tooth root canal, and can be easily manufactured.

Furthermore, as a “nozzle for insertion into a tooth root canal”, a suction nozzle, or a filler nozzle used for filling a tooth root canal with a filler as a fluid, can be mentioned.

The second aspect of the invention is a device for treating a tooth root canal comprising the nozzle for insertion into a tooth root canal according to the first aspect, and a fluid exchange means for exchanging the fluid with the nozzle for insertion into a tooth root canal via a fluid channel connected to an other end of the nozzle for insertion into a tooth root canal.

According to the second aspect, it is possible to obtain the same effects as for the invention of the first aspect.

The third aspect of the invention provides a suction nozzle inserted from one end side into a tooth root canal, and used for suctioning and discharging to a discharge channel connected to an other end, a treatment fluid injected into the tooth root canal,

comprising a cylindrical main body portion, and a cylindrical extension portion extending from the tip of the main body portion and having a smaller outer diameter than the main body portion,

said extension portion having an inner diameter of 0.15 mm or more, an outer diameter of 0.50 mm or less, and a length of 7 mm or less, and

said main body portion having an inner diameter larger than the inner diameter of said extension portion, and an outer diameter of 1.1 mm or less.

A cylindrical body, unlike a shape having a gradually reduced outer diameter and inner diameter (for example a tapered shape) can be easily manufactured even if its dimensions are small.

According to the third aspect of the invention, it is possible to manufacture a suction nozzle if, from the tip of an easily manufactured cylindrical main body portion, a likewise easily manufactured cylindrical extension portion is extended, and thus the manufacture can be easily carried out.

Further, the suction nozzle is comprises a main body portion and an extension portion having a smaller external radius than this main body portion, thus the procedure for suctioning and discharging the treatment fluid injected into the tooth root canal using this suction nozzle is as follows.

First, the suction nozzle is inserted into the tooth root canal from one end side. Thereupon, because the main body portion is stopped at a shallow portion of the tooth root canal, it cannot be inserted into a deep portion, but the extension portion can reach a deep portion of the tooth root canal. When the treatment fluid is suctioned in this state, the treatment fluid is suctioned into the inside of the extension portion after having reached the deep portion of the tooth root canal. The treatment fluid suctioned into the inside of the extension portion passes through the inside of the main body portion, and is discharged to a discharge passage connected to the other end side of the suction nozzle.

In order to prevent reoccurrence of diseases inside the root canal of a tooth, it is necessary for the treatment fluid to reach a position 2 mm or less towards the opening side from the root apex hole of the tooth root canal. It is known that the tooth root canal diameter at a position of 2 mm towards the opening side from the root apex hole of the tooth root canal is usually at least about 0.5 mm or more.

According to the third aspect of the invention, the outer diameter of the extension portion is 0.50 mm or less, thus the extension portion can usually be inserted to a position 2 mm or less towards the opening side from the root apex hole of the tooth root canal. Because of this, the treatment fluid injected into the tooth root canal, after reaching a position 2 mm or less towards the opening side from the root apex hole, is suctioned into the inside of the extension portion, and thus it is possible to inhibit reoccurrence of disease inside the root canal of the tooth.

However, if the outer diameter is made smaller, as a result of the inner diameter also becoming smaller, there are cases where the suction amount per unit time of the treatment fluid is insufficient.

According to the third aspect of the invention, the inner diameter of the extension portion is 0.15 mm or more, and further the length is 7 mm or less, and the inner diameter of the main body portion is larger than the inner diameter of the extension portion, thus it is possible to suppress reductions of the suctioned amount per unit time of the treatment fluid due to providing the extension portion, and therefore, a sufficient amount of the treatment fluid can be suctioned per unit time.

However, the outer diameter of the main body portion is 1.1 mm or less, thus the main body portion can usually be inserted to a position 9 mm or less towards the opening side from the root apex of the tooth root canal. Because of this, even if the length of the extension portion is 7 mm or less, by setting the outer diameter of the main body portion, it is possible to insert the extension portion to a position which is 2 mm or less towards the opening side from the root apex hole of the tooth root canal.

Accordingly, it is possible to inhibit the reoccurrence of diseases inside the root canal of the tooth, a sufficient amount of the treatment fluid can be suctioned per unit time, and further, the manufacture is easy.

Furthermore, the inner diameter, outer diameter, and length of the extension portion, and the inner dimension, outer dimension, and length of the main body portion can be suitably set within the scope of the present invention according to the shape and dimensions and the like of the subject tooth root canal.

For example, the length of the extension portion is preferably 6 mm or less from the point of improving the suctioned amount per unit time of the treatment fluid, and is preferably 5 mm or less (for example, 3 mm or less) from the point of inhibiting contaminants from becoming clogged in the opening of the extension portion. Further, in the case that the length of the extension portion is 5 mm or less, is preferable for the outer diameter of the main body portion to be 1.0 mm or less. From this, by inserting to a position 7 mm or less towards the opening side from the root apex hole of the tooth root canal, it is possible to insert the extension portion to a position 2 mm or less towards the opening side from the root apex hole of the tooth root canal.

The fourth aspect of the invention is a suction nozzle according to the third aspect,

in which one or both of the main body portion and the extension portion has a groove on an outer periphery portion and extending towards a tip of the extension portion.

When the suction nozzle is inserted into a tooth root canal, and the main body portion and/or the extension portion comes into contact with the tooth root canal, the channel for the treatment fluid inside the tooth root canal is blocked, and the treatment fluid does not reach the deep portion of the tooth root canal, or even if it does reach, the suction amount per unit time is insufficient. In such a case, in order to ensure a channel for the treatment fluid, it is necessary to carry out the suctioning of the treatment fluid in a state where the main body portion and/or extension portion is maintained suspended towards the opening of the tooth root canal so that their outer peripheries do not contact the tooth root canal. Because of this, not only are there cases where the tip of the extension portion does not attain a position 2 mm or less towards the opening side from the root apex hole of the tooth root canal, but the operation also becomes complicated.

According to the fourth aspect of the invention, a groove is provided at the outer periphery of the main body portion and/or the extension portion, extending in the direction of the tip of the extension portion. As a result, even if the outer periphery portion of the main body portion and/or the extension portion contacts the tooth root canal, the treatment fluid inside the tooth root canal can reach the deep portion of the tooth root canal via the groove.

Accordingly, it is possible to reliably insert the tip of the extension portion to a position 2 mm or less towards the opening side from the root apex hole of the tooth root canal, and additionally, the operability is improved.

Further, because the thickness is maintained at the portion where the groove is not formed, the main body portion and/or extension portion of the fourth aspect of the invention retains a higher degree of strength than a main body portion and/or extension portion where the thickness all around the periphery has been reduced.

Further, it is not necessary to provide the groove along all of the main body portion and/or extension portion, and the groove can be provided at a portion which contacts a tooth root canal when the suction nozzle is inserted into the tooth root canal. Accordingly, the groove can usually be provided in a range to an extent of 5 mm from the tip of the suction nozzle.

The fifth aspect of the invention is a suction nozzle according to the fourth aspect,

in which the groove is spirally formed.

According to the fifth aspect of the invention, because the groove has a spiral shape, by using the difference in strength between the portion where the groove is formed and the thickness is thin, and the portion where the groove is not formed and the thickness is thick, the main body portion and/or the extension portion are easy to bend along this groove.

Accordingly, the shape of the suction nozzle can be easily prepared in accordance with the shape and dimensions of the subject root canal.

The sixth aspect of the invention is a suction nozzle according to any one of the third to fifth aspects,

in which one or both of the main body portion and the extension portion has a tapered outer periphery portion.

According to the sixth aspect of the invention, the outer periphery of the main body portion and/or the extension portion is tapered, thus, the outer radius is reduced towards the tip, and therefore the occurrence of the situation where the main body portion and/or the extension portion is stopped at a shallow portion of the tooth root canal and cannot be inserted to a deep portion can be avoided with a higher probability.

Here, “tapered” means a shape which is reduced towards the direction of the tip of the extension portion.

The seventh aspect of the invention is a treatment device for a disease inside a root canal of a tooth, comprising an injection means for injecting a treatment fluid into a tooth root canal, and a discharge means for discharging the treatment fluid from the tooth root canal, in which the injection means comprising a treatment fluid holding means which holds a treatment fluid, and a supply nozzle which is communicated with the treatment fluid holding means via a supply channel and which supplies the treatment fluid to the tooth root canal, and

the discharge means comprises a suction nozzle inserted from one end side into the tooth root canal, a discharge channel connected to an other end of the suction nozzle, a suction means for suctioning the treatment fluid injected into the tooth root canal and provided in a path of the discharge channel, and a waste liquid holding means communicated with the suction nozzle via said discharge channel and holding the suctioned treatment solution, in which

the suction nozzle is the suction nozzle according to any one of the third to sixth aspects of the invention.

According to the seventh aspect of the invention, the same effects provided by the third to sixth aspects can be obtained.

### EFFECTS OF THE INVENTION

According to the present invention, a nozzle for insertion into a tooth root canal can be manufactured if, from a tip of an easily manufactured cylindrical main body portion, a likewise easily manufactured cylindrical extension portion is extended, and thus the manufacture can be easily carried out.

Further, the nozzle for insertion into a tooth root canal comprises a main body portion and an extension portion having a smaller outer diameter than the main body portion, thus while the main body portion cannot be inserted into a deep portion of the tooth root canal because it is stopped at a shallow portion, the extension portion can reach a deep portion of the tooth root canal. Because of this, a fluid can be injected into a deep portion of the tooth root canal, or can be suctioned from a deep portion of the tooth root canal.

Further, the inner diameter of the main body portion is larger than the inner diameter of the extension portion, thus it is possible to suppress reductions in the injection amount or the suction amount per unit time of the fluid due to the provision of the extension portion, and a sufficient amount of fluid can be injected or suctioned per unit time.

Accordingly, is it possible to inject into a deep portion of the tooth root canal, or suction from a deep portion of the tooth root canal, a sufficient amount of the fluid per unit time, and further the manufacture can be easily carried out.

### BRIEF DESCRIPTION OF THE DRAWINGS

FIG. 1 is a schematic constitutional view of a treatment device according to the first embodiment of the present invention;

FIG. 2 is a partially cutaway perspective view of the treatment device according to the above embodiment;

FIG. 3 is a full perspective view of the suction nozzle according to the above embodiment;

FIG. 4 is a half section view of FIG. 3;

FIG. 5 is a front elevation view of FIG. 3;

FIG. 6 is a view showing the state of use of the suction nozzle according to the above embodiment;

FIG. 7 is a full perspective view of the suction nozzle according to the second embodiment of the present invention;

FIG. 8 is a half section view of FIG. 7;

FIG. 9 is a front elevation view of FIG. 7;

FIG. 10 is a view showing the state of use of the suction nozzle according to the above embodiment;

FIG. 11 is a half section view of the suction nozzle according the third embodiment of the present invention;

FIG. 12 is a half section view of the suction nozzle according the fourth embodiment of the present invention;

FIG. 13 is a full perspective view of the treatment apparatus according to the fifth embodiment of the present invention;

FIG. 14 is a cross section view showing a disassembled state of the treatment device according to the above embodiment;

FIG. 15 is a half section magnified view of the principal parts of FIG. 14;

FIG. 16 is a schematic constitutional view of the treatment device according to the prior art; and

FIG. 17 is a full perspective view of another treatment device according to the prior art.

### PREFERRED MODE FOR CARRYING OUT THE INVENTION

Below, embodiments of the invention will be explained with reference to the drawings. Further, in the explanations of the embodiments other than the first embodiment, parts which are in common with the first embodiment have the same reference numbers, and explanations thereof are omitted.

### First Embodiment

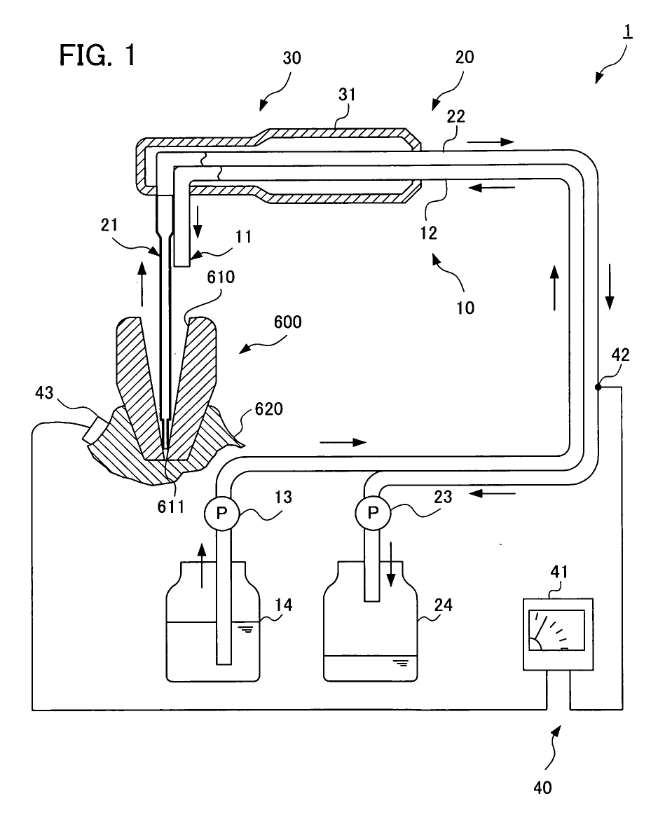

FIG. 1 is a schematic constitutional view of the treatment device 1 according to the first embodiment of the present invention.

The treatment device 1 is provided with an injection device 10 which injects treatment fluid into a tooth root canal, a discharge device 20 which discharges treatment fluid from the tooth root canal, a grasping portion 30 which houses a portion of the injection device 10 and the discharge device 20, and a root canal length measurement device 40 which measures the length of the tooth root canal.

The injection device 10 has a treatment fluid holding tank 14 as a treatment fluid holding means, a supply nozzle 11 which communicates with the treatment fluid holding tank 14 via a supply tube 12 as a supply channel, and a supply pump 13 provided in the path of the supply tube 12.

In the treatment fluid holding tank 14, a treatment fluid (fluid) is held, such as sodium hypochlorite, physiological saline, hydrogen peroxide, EDTA solution, distilled water or other medicated fluids, depending on the goal of the treatment.

The supply pump 13 is connected to the control device 60, explained later, and on/off control is carried out by this control device 60.

The supply tube 12 is not particularly limited, and is an elastic tube having corrosion resistance with respect to the treatment fluid.

The tip of the supply nozzle 11 is disposed at the upper portion of the opening of the tooth 600. Because of this, by operating the supply pump 13, treatment fluid supplied from the supply fluid holding tank 14 via the supply tube 12 is injected into the tooth root canal 610. Further, the supply nozzle 11 is formed of stainless steel, plastic, nickel titanium or the like.

The discharge device 20 has a suction nozzle 21, a discharge tube 22, as a discharge channel or fluid flow channel, connected to this suction nozzle 21, a discharge pump 23, as a suction means, for suctioning the treatment fluid injected into the tooth root canal 610 and provided in the path of the discharge tube 22, and a waste liquid holding tank 24, as a waste liquid holding means, communicated with the suction nozzle 21 via the discharge tube 22. The discharge pump 23 and the waste liquid holding tank 24 constitute a fluid exchange means.

The tip of the suction nozzle 21 is inserted into the tooth root canal 610. The detailed structure of the suction nozzle 21 is described later.

The discharge tube 22 is not particularly limited, and is an elastic tube having corrosion resistance with respect to the treatment fluid.

Further, the suction nozzle 21 and the discharge tube 22 are formed of an electrically conductive material so as to electrically connect to an oral cavity electrode 43 described later.

The discharge pump 23 is connected to a control device 60 described later, and on/off control is carried out by this control device 60.

By the operation of the discharge pump 23, the treatment fluid injected into the tooth root canal 610 is suctioned into the inside of the suction nozzle 21, and the suctioned treatment fluid is then conveyed to the waste liquid holding tank 24 via the discharge tube 22, and held in the waste liquid holding tank.

The grasping portion 30 has a grasping main body 31, and a hose 32 introduced into grasping portion main body 31. The hose 32 leads through the side face of the enclosure 50 described later, and bundles together the supply tube 12 and the discharge tube 22. Further, the discharge tube 22 and the supply tube 12 are led through from the grasping portion main body 31, and the discharge tube 22 is coupled with the coupling portion 213.

The root canal length measurement device 40 has a root canal length measurement instrument 41, and a measurement electrode terminal 42 and oral cavity electrode 43 connected to the root canal length measurement instrument 41.

The measurement electrode terminal 42 is connected to the discharge tube 22 constituted of a conductive material, and is electrically connected to the tip of the suction nozzle 21 via the discharge tube 22. On the other hand, the oral cavity electrode 43 is attached to the soft tissue of the lips or the like.

The root canal length measurement instrument 41 is an instrument which electrically measures the root canal length, and the display portion of this root canal length measurement instrument 41 displays the resistivity value between the tip of the suction nozzle 21 inserted into the tooth root canal 610, and the oral cavity electrode 43 attached to the soft tissue of the lips or the like. The user can ascertain the position of the tip of the suction nozzle 21 based on this resistivity value.

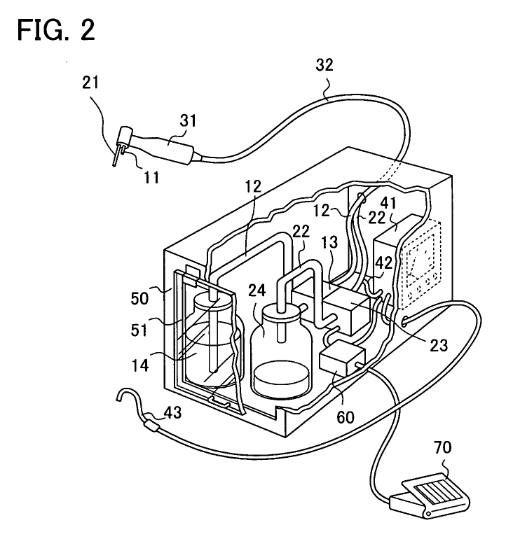

FIG. 2 is a partially cutaway perspective view of the treatment device according to the above embodiment. The treatment device 1 is further provided with an enclosure 50, a control device 60, and a foot controller 70 connected to the control device 60.

The inner portion of the enclosure 50 houses the treatment fluid holding tank 14 and waste liquid holding tank 24, the supply pump 13 and discharge pump 23, a portion of the supply tube 12 and discharge tube 22, the root canal length measurement device 40 and the measurement electrode 42, and the control device 60. The side face of the enclosure 50 is provided with the opening and closing door 51, and it is possible to remove and insert the treatment fluid holding tank 14 and the waste liquid holding tank 24 via this opening and closing door 51. Further, the opening and closing door 51 is constituted to be transparent or translucent, and the holding state of the treatment fluid holding tank 14 and the waste liquid holding tank 24 (for example, the held amount) can be observed via the opening and closing door 51.

The control device 60 controls the driving of the supply pump 13 and the discharge pump 23, and adjusts the on/off state and flow speed of the treatment fluid in accordance with the presence or absence, or the degree of the foot stepping operation of the foot controller 70.

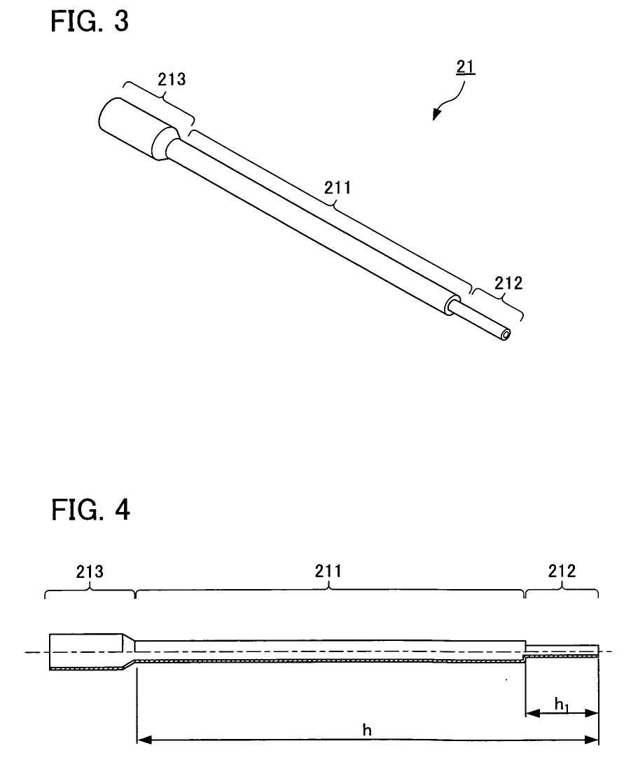

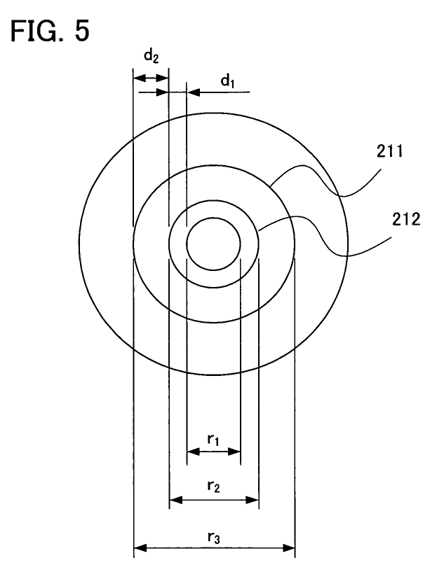

FIG. 3 is a full perspective view of the suction nozzle 21 according to the above embodiment. FIG. 4 is a half section view of FIG. 3. FIG. 5 is a front elevation view of FIG. 3.

The suction nozzle 21 is provided with an approximately cylindrical connection portion 213 which is connected at one end with the discharge tube 22, a main body portion 211 with an approximately cylindrical shape extending from the other end of this connection portion 213, and an extension portion 212 with an approximately cylindrical shape extending from the tip of this main body portion 211. The openings provided in the inner portions of the connection portion 213, main body portion 211, and extension portion 212 are communicated with each other.

The connection portion 213 is not particularly limited as long as it has a structure which can connect with the suction nozzle 21. Further, the connection portion 213 is usually formed of plastic.

The extension portion 212 has an inner diameter (r₁) of 0.15 mm or more (preferably 0.26 mm or more), an outer diameter (r₂) of 0.50 mm or less (preferably 0.42 mm or less), a length (h₁) of 7 mm or less (preferably 6 mm or less, and more preferably 5 mm or less (for example, 3 mm or less)).

The main body portion 211 has an inner diameter (r₂) which is larger than the inner diameter (r₁) of the extension portion 212, and an outer diameter (r₃) of 1.1 mm or less (preferably 1.0 mm or less if h₁ is 5 mm or less)

The main body portion 211 and the extension portion 212 are formed of stainless steel, plastic, nickel titanium or the like, and the total length (h) of the main body portion 211 and the extension portion 212 is usually 31 mm or more.

The main body portion 211 and the extension portion 212 are preferably welded together at their respective joining portions using a welding means such as a YAG laser or the like, from the point of inhibiting separation of the extension portion 212 from the main body portion 211.

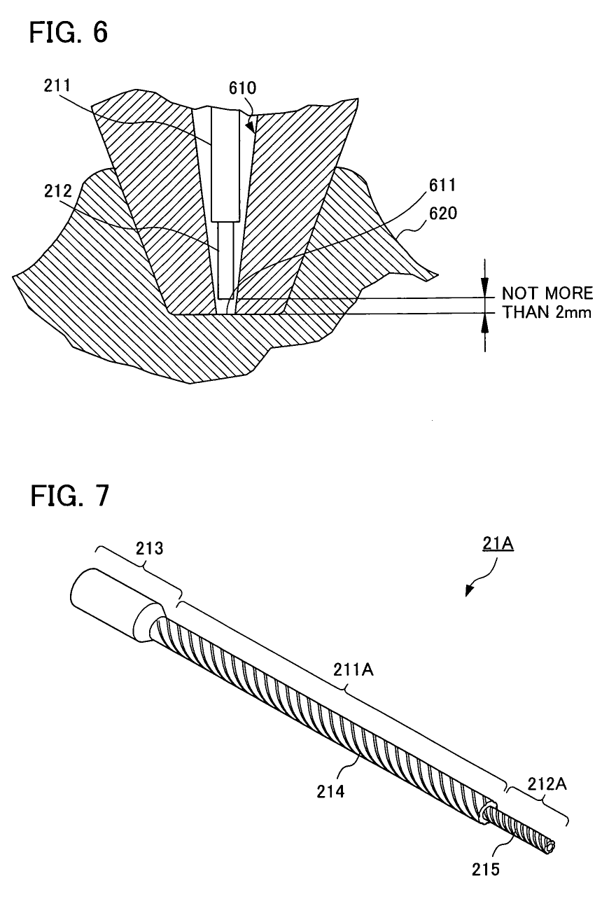

FIG. 6 is a view showing the state of use of the suction nozzle 21. Further, FIG. 6, in order to simplify and clarify the explanation, shows the inner portion of the tooth root canal 610.

The method of using the treatment device is as follows.

First, the measurement electrode terminal 42 is connected to the root canal measurement instrument 41, and the oral cavity electrode 43 is attached to the soft tissue of the lip or the like. Next, the grasping portion main body 31 is gripped, and the suction nozzle 21 is inserted from one end side into the tooth root canal 610. Based on the resistivity value displayed on the root canal measurement instrument 41, the length of the tooth root canal 610 is measured.

Following this, based on this measurement value, enlargement of the root canal is carried out using a specialized cutting instrument such as a reamer, file or the like. By this, in addition to removing the contaminants inside the tooth root canal 610, the tooth root canal 610 is put in a form which can be easily filled. Further, if a liquid with a strong medical effect, such as sodium hypochlorite is used as the treatment fluid, the treatment fluid injected into the inside of the tooth root canal 610 dissolves the tooth root canal 610, and thus the tooth root canal 610 is enlarged. As a result, it is not completely necessary to carry out a process for enlarging the root canal using a specialized cutting instrument.

Next, the grasping portion main body 31 is gripped, and the suction nozzle 21 is reinserted from one end side into the tooth root canal 610. Thereupon, the main body portion 211 is stopped at a shallow portion of the tooth root canal 610 and thus cannot be inserted into a deep portion, but the extension portion 212 reaches a deep portion of the tooth root canal 610. Specifically, the tip of the extension portion 212 reaches a position 2 mm or less in the upwards direction from the root apex hole 611. On the other hand, the tip of the supply nozzle 11 is placed upwards of the tooth root canal 610.

Next, in this state, by stepping on the foot controller 70, the supply pump 13 and the discharge pump 23 are operated by the control device 60. Thereupon, the treatment fluid supplied to the supply nozzle 11 from the treatment fluid holding tank 14 via the supply tube 12 is injected into the tooth root canal 610 from the tip of the supply nozzle 11, and after the injected treatment fluid has reached a position 2 mm or less in the upwards direction from the root apex hole 611, it is suctioned into the inside of the extension portion 212. The treatment fluid suctioned into the inside of the extension portion 212 is conveyed to the waste liquid holding tank 24 via the main body portion 211 and the discharge tube 22, and held in the waste liquid holding tank 24. The direction of flow of the treatment fluid is as shown by the arrows in FIG. 1.

Further, when the outer perimeter portion of the main body portion 211 and/or the extension portion 212 contacts the tooth root canal 610, if the treatment fluid cannot reach the deep portion of the tooth root canal 610, or even if it does reach the deep portion but has an insufficient suction amount per unit time, the suctioning of the treatment fluid may then be carried out so that the main body portion 211 and/or the extension portion 212 is maintained in a state raised towards the side of the opening of the tooth root canal 610.

Furthermore, at a suitable point in time, the stepping on the foot controller is released, and the supply pump 13 and the discharge pump 23 are stopped by the control device 60. Thereupon, the injection and suctioning of the treatment fluid are concluded. Then, the grasping portion 31 is gripped, the suction nozzle 21 is withdrawn from the tooth root canal 610, and one part of the treatment of the disease inside the tooth root canal is completed.

According to this embodiment, the following operational effects can be obtained.

(A) The suction nozzle 21 can be manufactured if, from the tip of an easily manufactured cylindrical main body portion 211, a likewise easily manufactured cylindrical extension portion 212 is extended, and thus the manufacture can be easily carried out.

Further, the outer diameter r₂ of the extension portion 212 is 0.5 mm or less, thus usually, the extension portion 212 can be inserted to a position 2 mm or less from the opening of the root apex hole 611. Because of this, the treatment fluid injected into the tooth root canal 610, after reaching a position 2 mm or less towards the opening side from the root apex hole 611, is suctioned into the inside of the extension portion 212, and therefore, it is possible to suppress reoccurrence of disease inside the root canal of the tooth 600.

Further, because the inner radius r₁ of the extension portion 212 is 0.15 mm or more, and the length h₁ is 7 mm or less, and the inner radius r₂ of the main body portion 211 is larger than the inner radius r₁ of the extension portion 212, it is possible to suppress reductions in the suction amount per unit time of the treatment fluid due to providing the extension portion 212, and thus it is possible to suction a sufficient amount of the treatment fluid per unit time.

However, because the outer radius r₃ of the main body portion 211 is 1.1 mm or less, it is usually possible to insert the main body portion 211 to a position 9 mm or less towards the opening side from the root apex hole 611. Because of this, even if the length h₁ of the extension portion 212 is 7 mm or less, by setting the outer radius r₃ of the main body portion 211 is it possible to insert the extension portion 212 to a position 2 mm or less towards the opening from the root apex hole 611.

Accordingly, it is possible to suppress reoccurrence of disease inside the root canal of the tooth 600, it is possible to suction a sufficient amount of the treatment fluid per unit time, and further the manufacture is easy.

### Second Embodiment

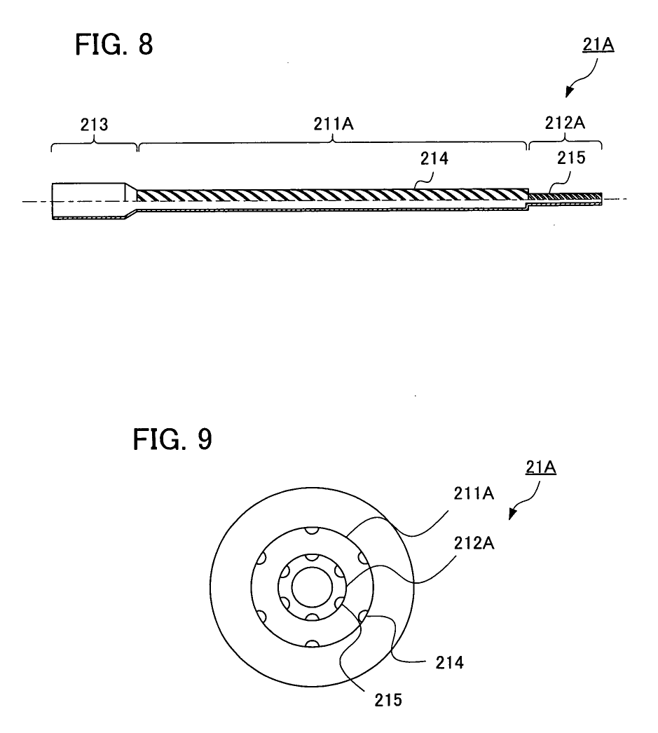

FIG. 7 is a full perspective view of the suction nozzle 21A according to the second embodiment of the present invention FIG. 8 is a half section view of FIG. 7. FIG. 9 is a front elevation view of FIG. 7.

In the present embodiment, the structures of the main body portion 211A and the extension portion 212A differ from the first embodiment.

Namely, the main body portion 211A and the extension portion 212A are each respectively provided on their outer periphery portions with a main body groove 214 and an extension groove 215 running towards the tip of the extension portion 212A. Each of the main body groove 214 and the extension groove 215 has a spiral shape.

The depth of the main body groove 214 and the extension groove 215, from the point of guaranteeing a flow channel for the treatment fluid, is preferably 0.01 mm or more, and from the point of maintaining the strength of the main body portion 212 and the extension portion 211, is 0.04 mm or less. More preferably, it is 0.02 mm or more, and 0.3 mm or less.

Further, the method of forming the main body groove 214 and the extension groove 215 is not particularly limited, and wire cut electrical discharge machining, or laser formation can be applied.

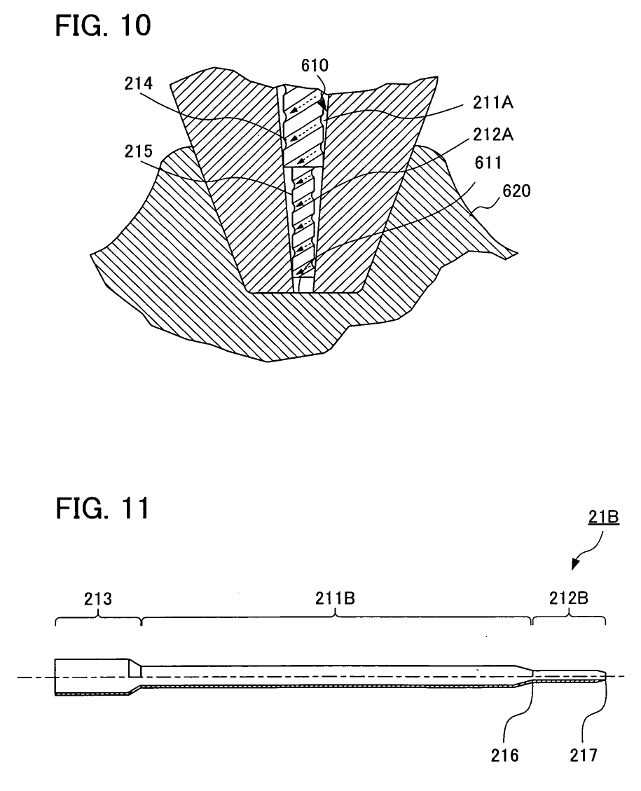

FIG. 10 is a view showing the state of use of the suction nozzle 21A according to the above embodiment. FIG. 10, in order to simplify the explanation, shows the inner portion of the tooth root canal 610, and the main body groove 214 and the extension groove 215 are shown larger than their actual size.

The method of using the treatment device according to the present embodiment differs from that of the first embodiment in the following points.

Namely, after carrying out enlargement of the root canal, the suction nozzle 21A is inserted from one end side into the tooth root canal 610, and the main body portion 211A and the extension portion 212A contact the tooth root canal 610, and the clearances between the end portions of the main body portion 211A and extension portion 212A, and the tooth root canal 610, become blocked.

In this state, by stepping on the foot controller 70, the supply pump 13 and the discharge pump 23 are activated by the control device 60. Thereupon, the treatment fluid supplied to the supply nozzle 11 from the treatment fluid holding tank 14 via the supply tube 12 is injected into the tooth root canal 610 from the tip of the supply nozzle 11, and the injected treatment fluid passes through the main body groove 214 and the extension groove 215, and after reaching a position 2 mm or less in the upwards direction from the root apex hole 611, is suctioned into the inside of the extension portion 212. The treatment fluid suctioned into the inside of the extension portion 212 is conveyed to the waste liquid holding tank 24 via the main body portion 211 and the discharge tube 22, and held in the waste liquid holding tank 24. The direction of the flow of the treatment fluid is shown by the arrows in FIG. 10.

According to the present embodiment, in addition to the operational effects provided by the first embodiment, the following operational effects can also be obtained.

(C) A main body groove 214 and an extension grove 215 are provided extending towards the tip of the extension portion 212A at the outer periphery portions of the main body portion 211A and the extension portion 212A. Because of this, even if the main body portion 211A and the extension portion 212A contact the tooth root canal 610, the treatment fluid inside the tooth root canal 610 can pass through the main body groove 214 and the extension groove 215, and thus it can reach a deep portion of the tooth root canal 610. Accordingly, it is possible to more reliably insert the tip of the extension portion 212A to a position 2 mm or less towards the opening from the root apex hole 611, and the operability can be improved.

(D) The portions where the main body groove 214 and the extension groove 215 are not formed maintain their thickness, and thus a high degree of strength can be maintained.

(E) The main body groove 214 and the extension groove 215 are formed in a spiral shape, thus the main body portion 211A and the extension portion 212A can easily bend along the main body groove 214 and the extension groove 215. Accordingly, the shape of the suction nozzle 21A can be easily formed in response to the shape and dimensions of the subject tooth root canal 610.

### Third Embodiment

FIG. 11 is a half section view of the suction nozzle 21B according the third embodiment of the present invention.

In the present embodiment, the structures of the main body portion 211B and the extension portion 212B differ from the first embodiment.

Namely, the tip portions 216 and 217 of the main body portion 211B and the extension portion 212B each have a tapered outer periphery.

According to the present embodiment, in addition to the above-mentioned operational effects of the first embodiment, it is possible to obtain the following operational effects.

(F) The tip portions 216 and 217 of the main body portion 211B and extension portion 212B are constituted to have a tapered outer periphery portion, thus the occurrence of the situation that the main body portion 211B and the extension portion 212B are stopped at a shallow portion of the tooth root canal 610 and cannot be inserted to a deep portion can be prevented with a high degree of likelihood.

### Fourth Embodiment

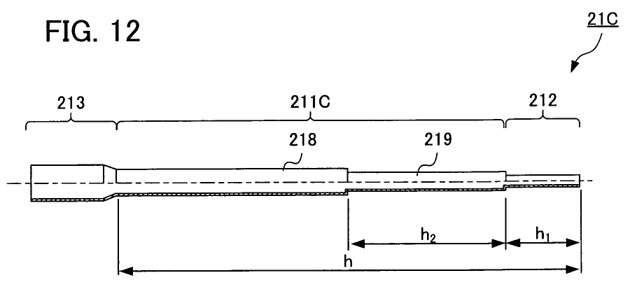

FIG. 12 is a half section view of the suction nozzle 21C according the fourth embodiment of the present invention.

In the present embodiment, the main body portion 211C has a constitution differing from the first embodiment.

Namely, the main body portion 211C is provided with a large main body portion 218 extending from the end portion of the connection portion 213 and having an approximately cylindrical shape, and a small main body portion 219 extending from the tip of this large main body portion 218 and further, having an outer diameter which is smaller than the large main body portion 218, and having an approximately cylindrical shape. The tip of this small main body portion 219 is connected to an end portion of the extension portion 212.

The inner diameter of the small main body portion 219 is larger than the inner diameter of the extension portion 212, and its outer diameter is 0.65 mm or less, and its length (h₂) is 8.0 mm or less.

The large main body portion 218 has an inner diameter which is larger than the inner diameter of the small main body portion 219, and its outer diameter is 0.9 mm or less (for example, 0.8 mm or less).

According to the present embodiment, in addition to the effects of the above mentioned first embodiment, the following effects can be obtained.

(G) It is possible to manufacture a main body portion 211C if, from the tip of an easily manufactured cylindrical large main body portion 218, a likewise easily manufactured cylindrical small main body portion 219 is extended, and thus the suction nozzle 21C can be easily manufactured.

Further, by constituting the main body portion 211C of the large main body portion 218 and the small main body portion 219, because the inner diameter of the small main body portion is larger than the inner diameter of the extension portion 212, and further, the inner diameter of the large main body portion 218 is larger than the inner diameter of the small main body portion 219, it is possible to improve the suction amount per unit time of the treatment fluid.

Further, because the outer diameter of the large main body portion is less than 0.9 mm, it is usually possible to insert the large main body portion 218 to a position 17 mm or less towards the opening from the root apex hole 611 (usually, the diameter of the tooth root canal 610 at 17 mm towards the opening from the root apex hole 611 is 1.2 mm). Because of this, even if the length of the extension portion 212 is 7 mm or less, by setting the length h₂ and the outer diameter of the small main body portion 219, it is possible to insert the extension portion 212 to a position 2 mm or less towards the opening from the root apex hole 611.

Accordingly, it is possible to suppress reoccurrence of disease inside the root canal of the tooth 600, a sufficient amount of the treatment fluid can be suctioned per unit time, and further, the manufacture is easy.

### Fifth Embodiment

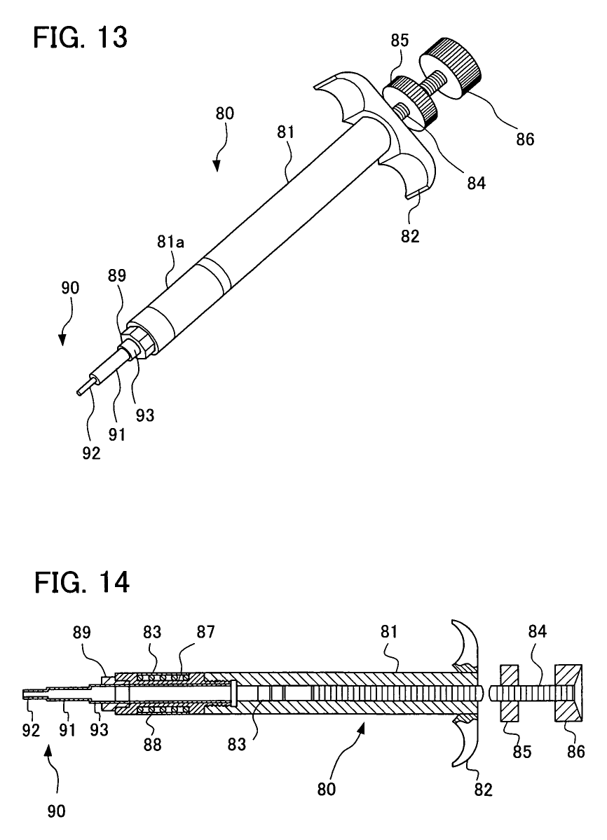

FIG. 13 is a full perspective view of the treatment apparatus according to the fifth embodiment of the present invention. FIG. 14 is a cross section drawing showing a disassembled state of the treatment device according to the above embodiment.

The treatment device 8 is provided with a cylindrical cylinder 81 having an internal supply source of filler, not shown in the drawing, a handle 82 positioned at one end of the cylinder 81, and a cylindrical filler nozzle 90 protruding from the other end of the cylinder 81.

The inner portion of the cylinder 81 is slidably engaged with a piston 83, and by sliding this piston 83 towards the other end side of the piston 81, the filler is extruded. From this piston 83, a rod 84 slidable on the inner portion of 81 extends, and a stop nut 85 and an operation pad 86 are sequentially screw-engaged on the rod 84 by a screw portion provided on its side face.

At the tip of the cylinder 81, a cylindrical heating mechanism 87 is provided. This heating mechanism 87, has, at the inner portion of a heat insulating sleeve 81a, a heat conducting wire 88 installed in a spiral shape. The heat conducting wire 88 is connected to a power source, not shown in the drawing, and when electrical power is provided by this power source, heat is released by the heat conducting wire 88.

The inner portion of the cylinder 81 constitutes a fluid channel, and the cylinder 81 and the piston 83 constitute a fluid exchange means.

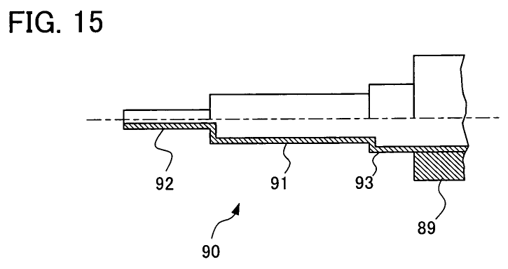

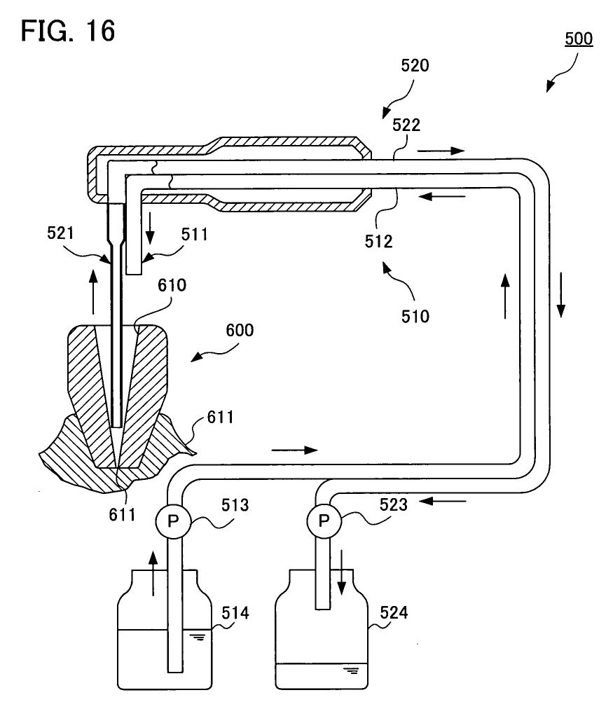

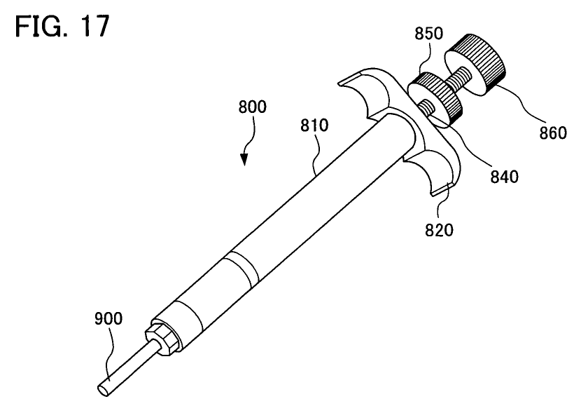

FIG. 15 is a half section magnified view of the principal parts of FIG. 14.

A hub 89 is provided at the other end of the cylinder 81.

The filler nozzle 90 is provided with an approximately cylindrical communicating portion 93 one end of which communicates with the cylinder 81 via the hub 89, and an approximately cylindrical main body portion 91 extending from the other end of the communicating portion 93, and an approximately cylindrical extension portion 92 extending from the tip of the main body portion 91. The openings provided at the inner portions of the communicating portion 93, main body portion 91, and extension portion 92 are communicated with each other. Further, the communicating portion 93, main body portion 91, and the extension portion 92 are preferably formed of highly thermally conductive materials, and for example, may be formed of stainless steel or nickel titanium.

The outer diameter and inner diameter of the extension portion 92 are both smaller than the main body portion 91. Specifically, the extension portion 92 has an inner diameter of 0.15 mm or more (preferably 0.30 mm or more), an outer diameter of 0.50 mm or less (preferably 0.40 mm or less), and a length of 7 mm or less (preferably 6 mm or less, more preferably 5 mm or less (for example, 3 mm or less)), and the main body portion 91 has an outer diameter of 1.1 mm or less (preferably 1.0 mm or less in the case that the length of the extension portion 92 is 5 mm or less). Further, the total length (h) of the main body portion 211 and the extension portion 212 is usually 31 mm or more.

The communicating portion 93 is not particularly limited as long as it has a structure which can communicate with the cylinder 81.

The method of using the treatment device 8 is as follows.

First, by grasping the handle 82 and pulling the operation pad 86 in the rearwards direction, the piston 83 is withdrawn from the cylinder 81. Next, after replenishing the filler as a fluid (for example, gutta-percha or resin) in the inner portion of the cylinder 81 the piston 83 is inserted into the cylinder 81. After providing the filler, electrical power is provided from the power source to the heat conducting wire 88 and heat is released from the heat conducting wire 88, and the heated filler (for example, to about 110° C.) is fluidized.

Next, the filler nozzle 90 is inserted into the tooth root canal from one end side. Thereupon, the main body portion 91 is stopped at a shallow portion of the tooth root canal and thus cannot be inserted to a deep portion, but the extension portion 92 can reach a deep portion of the tooth root canal. Specifically, the tip of the extension portion 92 reaches a position 2 mm or less from the root apex hole.

In this state, the operation pad 860 is pushed in the forwards direction, and the fluidized filler is supplied to the filler nozzle 900, passes through the main body portion 91 and the extension portion 92, and is injected from the tip of the filler nozzle 900 into the tooth root canal.

After this, at a suitable point in time, the filler nozzle 900 is withdrawn from the tooth root canal, and the filling of the inside of the tooth root canal is completed.

According to the present embodiment, the following operational effects can be obtained.

(H) A supply nozzle 90 can be manufactured if, from the tip of an easily manufactured cylindrical main body portion 91, a likewise easily manufactured cylindrical extension portion 92 is extended, and thus the manufacture can be easily carried out.

Further, the filler nozzle 90 has a constitution including a main body portion 91, and an extension portion 92 having an outer radius which is smaller than the main body portion 91, thus while the main body portion 91 is stopped at a shallow portion of the tooth root canal and cannot be inserted to a deep portion, the extension portion 92 can reach a deep portion of the tooth root canal. As a result, the filler can be injected to a deep portion of the tooth root canal, and the tooth root canal can be filled to its deep portions.

Further, the inner diameter of the main body portion 91 is larger than the inner diameter of the extension portion 92, thus it is possible to suppress reductions in the injected amount per unit time of the filler due to providing the extension portion 92, and a sufficient amount of the filler can be injected per unit time. From this, it is possible to suppress the occurrence of situations where the filler cools and solidifies in the inner portion of the filler nozzle 90 and the inside of the filler nozzle 90 becomes blocked.

Accordingly, injection to a deep portion of the tooth root canal is possible and further a sufficient amount of the fluid can be circulated per unit time, and the manufacture is easy.

### Examples

### Examples 1 to 3

### Comparative Examples 1 and 2

In Examples 1 to 3, and Comparative Examples 1 and 2, suction nozzles made of stainless steel having the dimensions shown in Table 1 were manufactured.

TABLE 1

| | | Outer Diameter | Inner Diameter | Length |
|---|---|---|---|---|
| | | (mm) | (mm) | (mm) |
| Comparative Example 1 | | 0.41 | 0.19 | 36.71 |
| Comparative Example 2 | | 0.63 | 0.33 | 31.20 |
| Example 1 | Large Main | 0.81 | 0.51 | 12.7 |
| | Body Portion | | | |
| | Small Main | 0.63 | 0.33 | 3.2 |
| | Body Portion | | | |
| | Extension | 0.41 | 0.19 | 3.4 |
| | Portion | | | |
| Example 2 | Main Body | 0.63 | 0.33 | 17.6 |
| | Portion | | | |
| | Extension | 0.41 | 0.19 | 3.3 |
| | Portion | | | |
| Example 3 | Main Body | 0.65 | 0.44 | 22.6 |
| | Portion | | | |
| | Extension | 0.42 | 0.261 | 3.3 |
| | Portion | | | |

### Evaluation of the Suction Amount Per Unit Time

The nozzles made according to Examples 1 to 3, and Comparative Examples 1 and 2 were used in the treatment device explained in the first embodiment. The suction amount per unit time was measured under the conditions of a suction pressure of 20 kPa when the tip of each of the suction nozzles for the treatment device was inserted into water filling a beaker. The results are shown in Table 2.

TABLE 2

| | Suction Amount per Unit Time (mL/min) |
|---|---|
| Comparative Example 1 | 2.09 |
| Comparative Example 2 | 27.90 |
| Example 1 | 8.50 |
| Example 2 | 8.83 |
| Example 3 | 16.07 |

As shown by Table 1 and Table 2, the nozzles of Examples 1 to 3, compared to the nozzle of Comparative Example 1, despite having approximately the same external diameter of the tip, have a larger suction amount per unit time.

On the other hand, the nozzle of Comparative Example 2, compared to Examples 1 to 3, has a larger suction amount per unit time, however, because the external diameter is too large, it cannot be inserted into the deep portion of a tooth root canal (for example, to a position 2 mm towards the opening from the perforation).

### Examples 4 to 8

In Examples 4 to 8, except for the point that the length of the extension portion is changed, suction nozzles of stainless steel were manufactured with common dimensions. The main body portion had dimensions of an inner diameter of 0.439 mm, and outer diameter of 0.649 mm, and the extension portion had dimensions of an inner diameter of 0.261 mm, an outer diameter of 0.42 mm, and the suction nozzle had an overall length of 31 mm.

TABLE 3

| | Length of Extension Portion (mm) |
|---|---|
| Example 4 | 3 |
| Example 5 | 4 |
| Example 6 | 5 |
| Example 7 | 6 |
| Example 8 | 7 |

### Evaluation of the Suction Amount Per Unit Time

The nozzles manufactured in Examples 4 to 8 were used in the treatment device explained in Example 1. The suction amount per unit time was measured under the conditions of a suction pressure of 20 kPa when the tip of each nozzle of the treatment device was inserted into water filling a beaker. The results are shown in Table 4.

TABLE 4

| | Suction Amount per Unit Time (mL/min) |
|---|---|
| Example 4 | 16.62 |
| Example 5 | 16.83 |
| Example 6 | 16.61 |
| Example 7 | 16.35 |
| Example 8 | 15.30 |

As shown by Tables 3 and 4, the nozzles of Examples 4 to 8, compared to Comparative Example 1, all suctioned a large amount of water per unit time. According to this, it was confirmed that extension portions on nozzles with the above mentioned dimensions, having a length of 7 mm or less, show excellent suction amounts per unit time, and in particular for lengths of 6 mm or less, an even more excellent suction amount per unit time was confirmed.

### Examples of Variations

The present invention is not limited to the above disclosed embodiments, and variations or improvements within a scope which can accomplish the objectives of the present invention are also included in the present invention.

In each of the above embodiments, each of the parts constituting the suction nozzle 21 and the filler nozzle 90 (for example, the main body portion 211, the extension portion 212) were formed as a single body, but the invention is not limited to this, and they may be formed separately. For example, it may be constituted so that one end of the extension portion 212 is inserted into and communicates with the inner portion of the main body portion 211.

Further, the main body portion 211 and the extension portion 212 constituting the suction nozzle 21, and the main body portion 91 and the extension portion 92 constituting the filler nozzle 90 were formed with an approximately cylindrical shape in each of the embodiments, but the invention is not limited to this, and they may for example be formed in an elliptical shape.

The suction nozzle 21, as shown in FIG. 2, may be used as is in a straight line form, but the invention is not limited to this, and it may be used with bends in appropriate locations. According to this, it may be advantageously inserted into root canals of teeth having a variety of positions, forms and angles.

The main body portion 211B and the extension portion 212B are formed with tapers only at the tip portions 216 and 217, but this is not a limitation, and the tapers my be formed over a wider range. Accordingly, the range of the tapers may be appropriately set according to the conditions of use of the suction nozzle.

1. A nozzle for insertion into a tooth root canal, inserted from one end side into the tooth root canal, and used for injecting into the tooth root canal or suctioning from the tooth root canal a fluid, comprising:
a cylindrical main body portion, and
a cylindrical extension portion extending from a tip of said main body portion, and having an outer diameter and an inner diameter each of which is smaller than said main body portion.

2. A device for treating a tooth root canal comprising the nozzle for insertion into a tooth root canal according to claim 1, and a fluid exchange means for exchanging the fluid with said nozzle for insertion into a tooth root canal via a fluid channel connected to an other end of said nozzle for insertion into a tooth root canal.

3. A suction nozzle inserted from one end side into a tooth root canal, and used for suctioning and discharging to a discharge channel connected to an other end, a treatment fluid injected into the tooth root canal, comprising
a cylindrical main body portion, and
a cylindrical extension portion extending from a tip of said main body portion and having a smaller outer diameter than said main body portion,
said extension portion having an inner diameter of 0.15 mm or more, an outer diameter of 0.50 mm or less, and a length of 7 mm or less, and
said main body portion having an inner diameter larger than the inner diameter of said extension portion, and an outer diameter of 1.1 mm or less.

4. A suction nozzle according to claim 3, wherein one or both of said main body portion and said extension portion has a groove on an outer periphery portion and extending towards a tip of said extension portion.

5. A suction nozzle according to claim 4, wherein said groove is spirally formed.

6. A suction nozzle according to claim 3, wherein one or both of said main body portion and said extension portion has a tapered outer periphery portion.

7. A treatment device for a disease inside a root canal of a tooth, comprising an injection means for injecting a treatment fluid into a tooth root canal, and a discharge means for discharging the treatment fluid from said tooth root canal,
said injection means comprising a treatment fluid holding means which holds a treatment fluid, and a supply nozzle communicated with said treatment fluid holding means via a supply channel and which supplies the treatment fluid to said tooth root canal,
said discharge means comprises a suction nozzle inserted from one end side into the tooth root canal, a discharge channel connected to an other end of said suction nozzle, a suction means for suctioning the treatment fluid injected into the tooth root canal and provided in a path of said discharge channel, and a waste liquid holding means communicated with said suction nozzle via said discharge channel and which holds suctioned treatment fluid, wherein said suction nozzle comprising
a cylindrical main body portion,
a cylindrical extension portion extending from a tip of said main body portion and having a smaller outer diameter than said main body portion,
said extension portion having an inner diameter of 0.15 mm or more, an outer diameter of 0.50 mm or less, and a length of 7 mm or less, and
said main body portion having an inner diameter larger than the inner diameter of said extension portion, and an outer diameter of 1.1 mm or less.

8. The treatment device according to claim 7, wherein one or both of said main body portion and said extension portion has a groove on an outer periphery portion and extending towards a tip of said extension portion.

9. The treatment device according to claim 8, wherein said groove is spirally formed.

10. The treatment device according to claim 9, wherein one or both of said main body portion and said extension portion has a tapered outer periphery portion.

11. The treatment device according to claim 7, wherein one or both of said main body portion and said extension portion has a tapered outer periphery portion.
